(19) United States
(12) Patent Application Publication
(10) Pub. No.: US 2018/0290582 A1
(43) Pub. Date: Oct. 11, 2018

(54) STRAP TENSIONING SYSTEM

(71) Applicant: Yeh-Chien Chou, Taoyuan City (TW)

(72) Inventor: Yeh-Chien Chou, Taoyuan City (TW)

(73) Assignee: STRONG YUN INDUSTRIAL CO., LTD., Taotuan City (TW)

(21) Appl. No.: 15/484,192

(22) Filed: Apr. 11, 2017

(51) Int. Cl. B60P 7/08

(52) U.S. Cl. CPC B60P 7/083; B60P 7/0853

(57) ABSTRACT

The system includes a body having a first side wall, a second side wall and a rod therebetween; a main shaft set, pivoted between the first and second side walls, including a main shaft, an end of the main shaft being disposed a ratchet and a first bevel gear; a transmission shaft, pivoted outside the second side wall of the body, a second bevel gear being axially connected around the transmission shaft, the second bevel gear engaging with the first bevel gear, and a gear ratio of the first and second bevel gears being 2:1; a handle set axially connected to the transmission shaft; and a pawl set pivoted on the second side wall of the body to fit into a notch of the ratchet to prevent the main shaft set from reversing.

### BACKGROUND OF THE INVENTION

### 1. Technical Field

The invention relates to devices tensioning a strap for securing cargo in a vehicle, particularly to ratchet-type strap tensioners.

### 2. Related Art

U.S. Pat. No. 9,061,622 provides a typical strap tensioner. Such a strap tensioner includes a frame comprising a first side wall that retains a ledge. A core shaft retains a flexible shaft and is rotatable by a drive shaft as urged by a crank handle. The crank handle supports an arm that is pivotable with respect to the crank handle, between a stowed position where the arm is substantially parallel to the crank handle, and a locking position where the arm is substantially perpendicular to the crank handle. The crank handle and arm are configured such that the arm disposed within the ledge when the crank handle is in registry with the ledge and the arm is in the locked position, thereby preventing rotation of the crank handle with respect to the frame. An end of the core shaft supports a worm gear. A retaining clip is seated in an annular undercut on the core shaft and axially captures a washer against the worm gear. The worm gear has teeth that move within a spiral groove formed on a worm. The worm is mounted to the drive shaft.

However, the worm gear has 16 teeth, so the worm gear can be turned merely 360 degrees by rotating the worm 16 turns. It is very laborious and time-consuming when tensioning a strap. Also, the crank handle cannot be extended to make a laborsaving effect.

### SUMMARY OF THE INVENTION

An object of the invention is to provide a strap tensioning system, which can quickly tension or rewind a strap.

Another object of the invention is to provide a strap tensioning system, which has a retractable handle set to make a laborsaving and space-saving effect.

To accomplish the above objects, the strap tensioning system of the invention includes a body having a first side wall, a second side wall and a rod therebetween; a main shaft set, pivoted between the first and second side walls, including a main shaft, an end of the main shaft being disposed a ratchet and a first bevel gear; a transmission shaft, pivoted outside the second side wall of the body, a second bevel gear being axially connected around the transmission shaft, the second bevel gear engaging with the first bevel gear, and a gear ratio of the first and second bevel gears being 2:1; a handle set axially connected to the transmission shaft; and a pawl set pivoted on the second side wall of the body to fit into a notch of the ratchet to prevent the main shaft set from reversing. The handle set is retractable to extend its moment ram or to shorten its length.

### BRIEF DESCRIPTION OF THE DRAWINGS

FIG. 1 is a perspective view of the invention with the handle set retracted;

FIG. 2 is a perspective view of the invention with removing the protective cover;

FIG. 3 is a perspective view of the invention with attaching the protective cover;

FIG. 4 is an exploded view of the invention;

FIG. 5 is a perspective view of the handle set retracted of the invention;

FIG. 6 is a perspective view of the handle set extended of the invention;

FIG. 7 is a plan view of the handle set of the invention when its claw is switched to a forward mode;

FIG. 8 is a plan view of the handle set of the invention when its claw is switched to a neutral mode;

FIG. 9 is a plan view of the handle set of the invention when its claw is switched to a reverse mode;

FIG. 10 is a plan view of the pawl set of the invention when it is in a self-lock status;

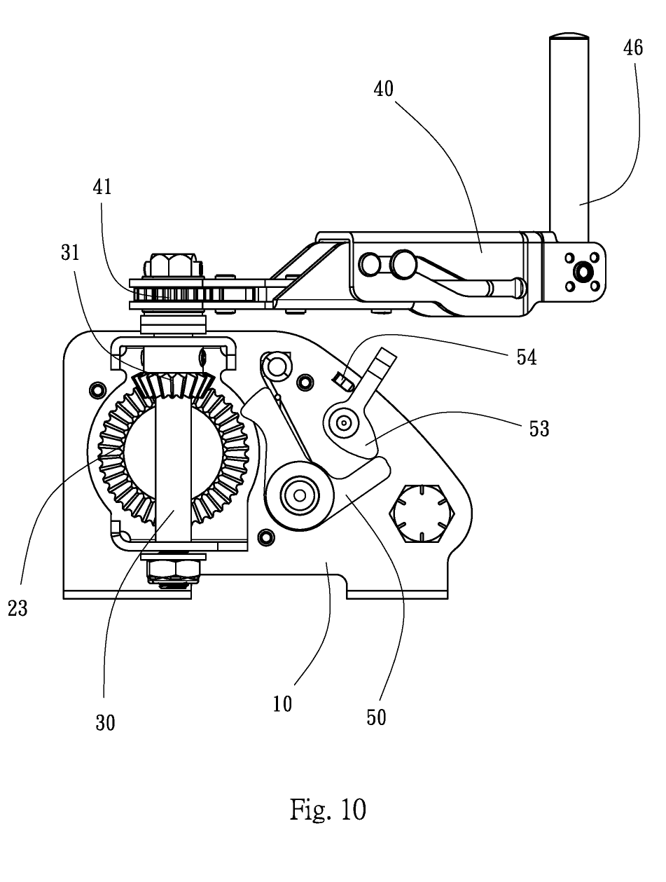

FIG. 11 is a schematic view of the invention when the main shaft set is rotated to make a ratchet tooth push the pawl;

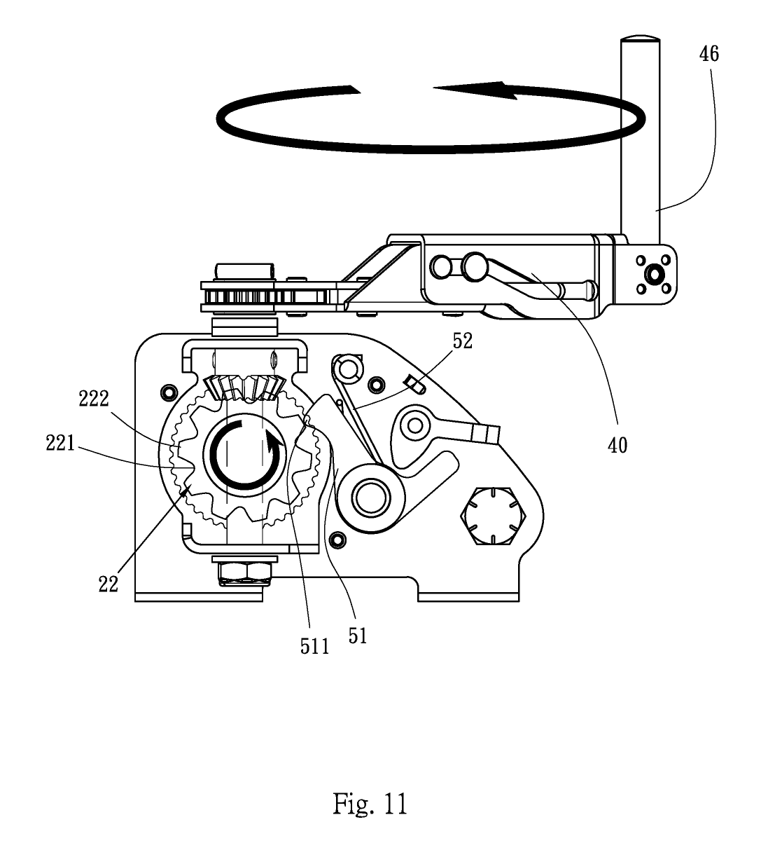

FIG. 12 is a schematic view of the invention when the main shaft set is rotated to make the pawl embedded into a ratchet notch; and

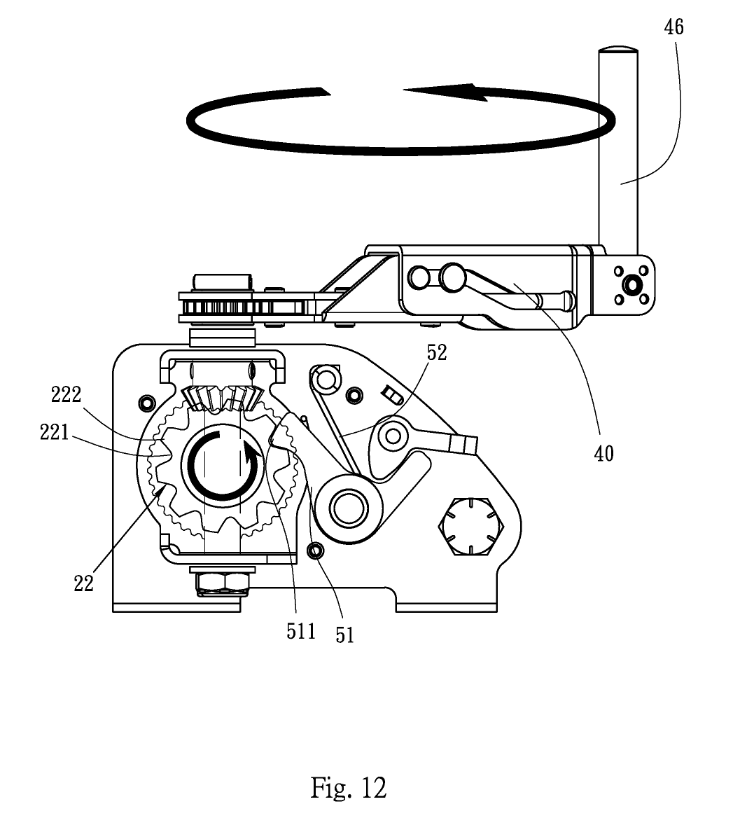

FIG. 13 is a schematic view of the invention with a strap.

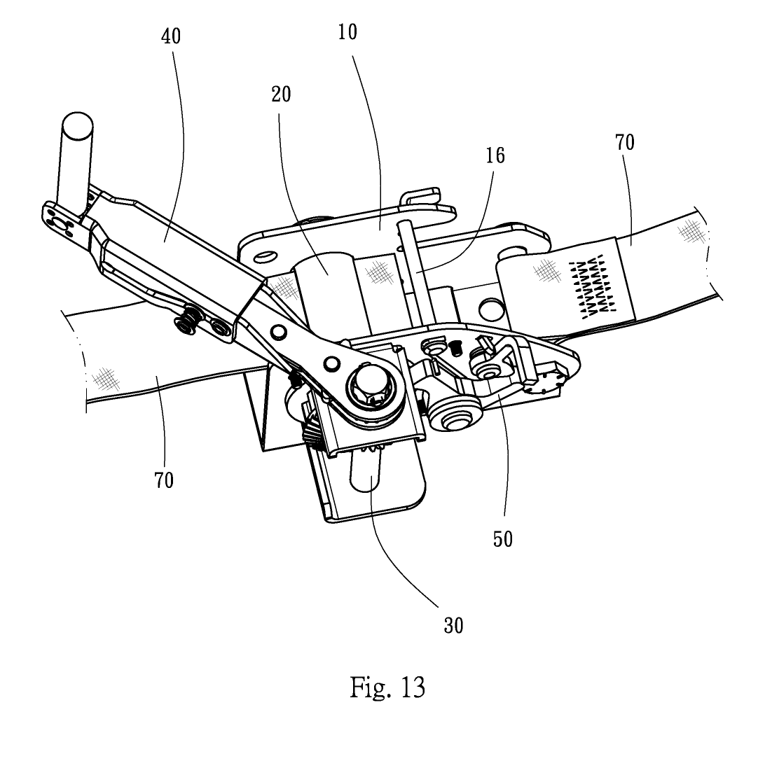

### DETAILED DESCRIPTION OF THE INVENTION

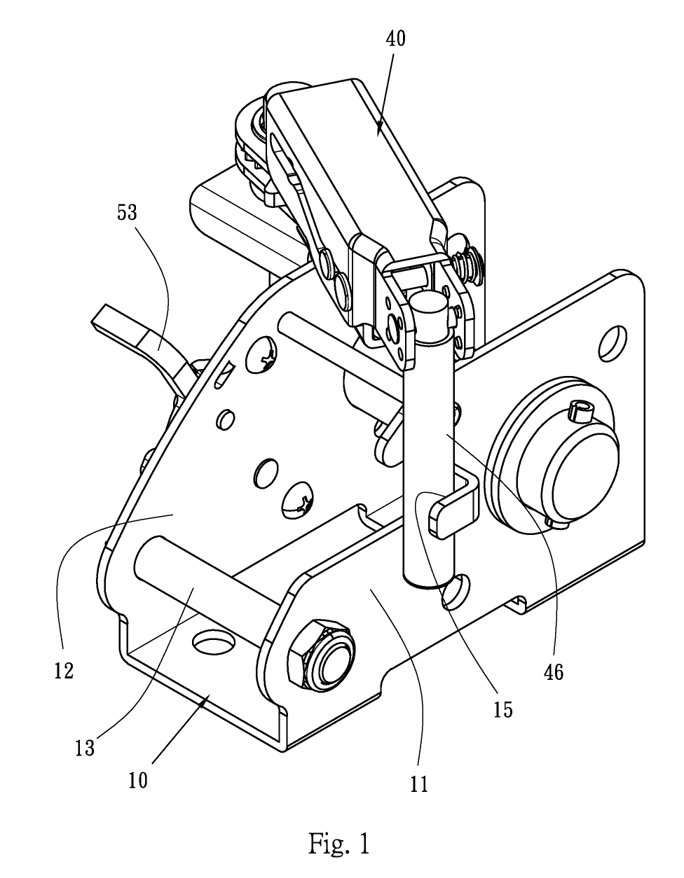

Please refer to FIGS. 1-3. The strap tensioning system of the invention includes a body 10, a main shaft set 20, a transmission shaft 30, a handle set 40 and a pawl set 50.

The body 10 has a first side wall 11, a second side wall 12 and a rod 13 between the first and second side walls 11, 12.

The main shaft set 20 is pivoted between the first and second side walls 11, 12. The main shaft set 20 has a main shaft 21. An end of the main shaft 21, which projects from the second side wall 12, is disposed a ratchet 22 and a first bevel gear 23. The main shaft 21, the ratchet 22 and the first bevel gear 23 are integrated in a single piece. The main shaft 21 is provided with a strap slot 211.

The transmission shaft 30 is pivoted outside the second side wall 12 of the body 10. A second bevel gear 31 is axially connected around the transmission shaft, 30. The second bevel gear 31 engages with the first bevel gear 23. A gear ratio of the first and second bevel gears 23, 31 is set to be 2:1.

The handle set 40 is axially connected to the transmission shaft 30 for rotating the transmission shaft 30.

The pawl set 50 is pivoted on the second side wall 12 of the body 10. A pawl 51 of the pawl set 50 fits into a notch 221 of the ratchet 22 to prevent the main shaft set 20 from reversing.

To quicken the driving speed, the invention uses the first bevel gear 23 engaging with the second bevel gear 31. The second bevel gear 31 is shaped to 20 teeth and the first bevel gear 23 is shaped to 40 teeth, so that their gear ratio is 1:20. In comparison with ‘622’s 1:16 of gear ratio, the invention is 8 times as quick as it.

Please refer to FIGS. 1-4, the ratchet 22 has ratchet teeth 222 and notches 221 between two adjacent teeth 222. The pawl 51 of the pawl set 50 is formed into a V-shape. A side end of the pawl 51 is formed to a pawl tip 511 which is pressed by a torsion spring 52 so that the pawl tip 511 can be normally embedded into a ratchet notch 221. A cam 53 is pivoted onto the second side wall 12 of the body 10 near the pawl 51. A limiting block 54 is fixed on the second side wall 12 to prevent the cam 53 from overturning. The cam 53 will not be pressed by the torsion spring 52 when it rotates over the dead point to make the pawl set 52 have a self-lock function and the main shaft set 20 freely rotatable. The ratchet 22 and the pawl set 50 can prevent the strap 70 from releasing or loosening.

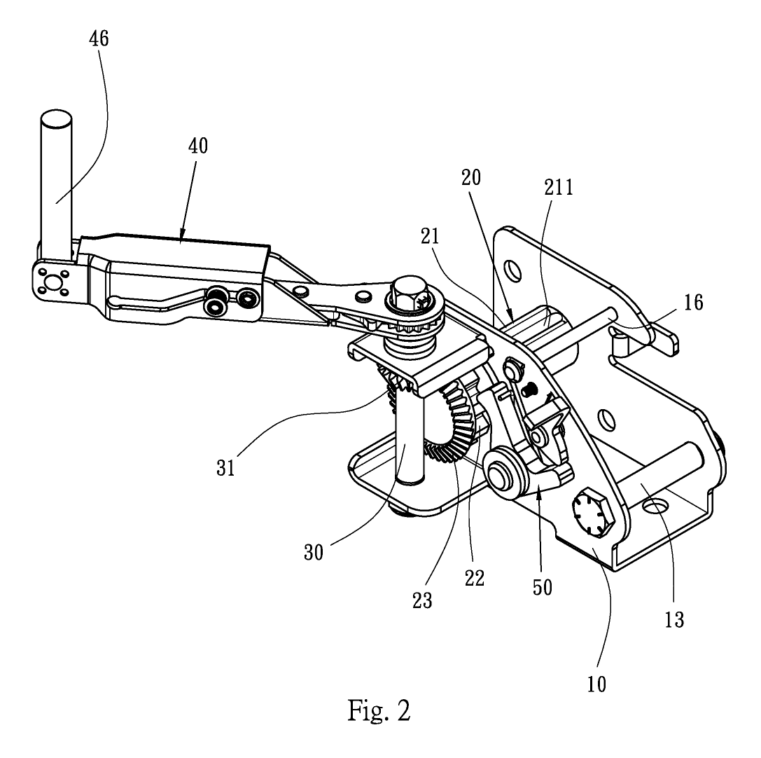

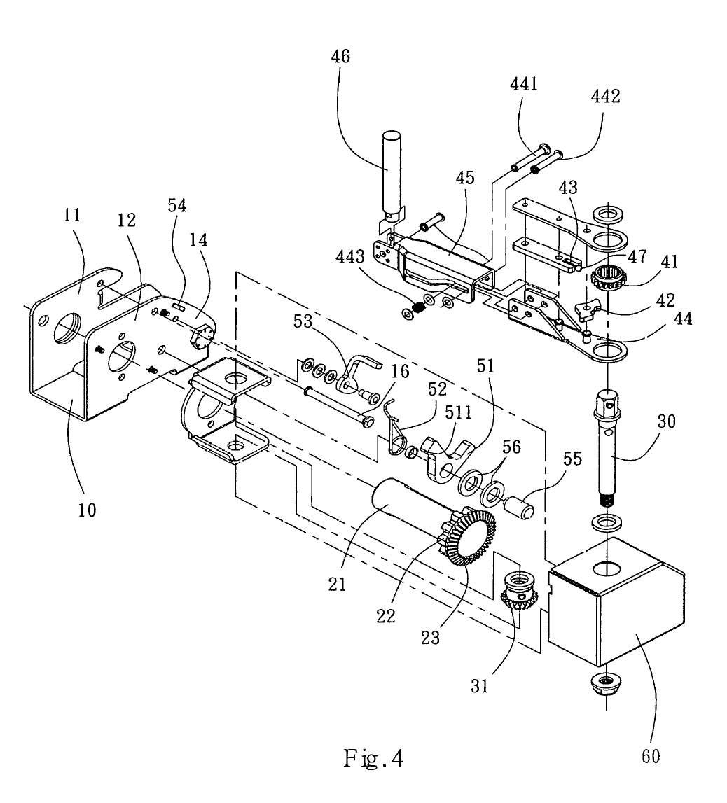

Please refer to FIGS. 2 and 4. A bar 16 is disposed between the two side walls 11, 12 of the body 10. The bar 16 is parallel to the main shaft set 20 to keep the distance between the two side walls 11, 12 and to be hooked by the torsion spring 52.

Please refer to FIG. 4. The pawl 51 and the torsion spring 52 are pivoted to the second side wall 12 of the body 10 by a pin 55 and two washers 56. The pin 55 and the washers 56 are made of stainless steel to resist thermal conduction when welding. This can prevent the body 10 electroplated from zinc-deplating due to overheat.

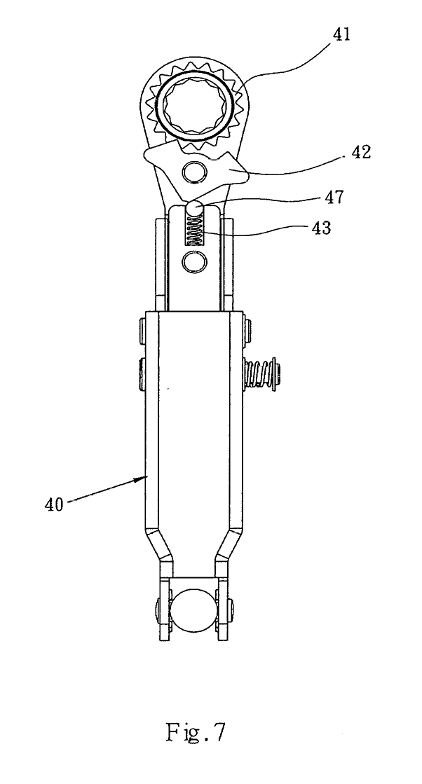

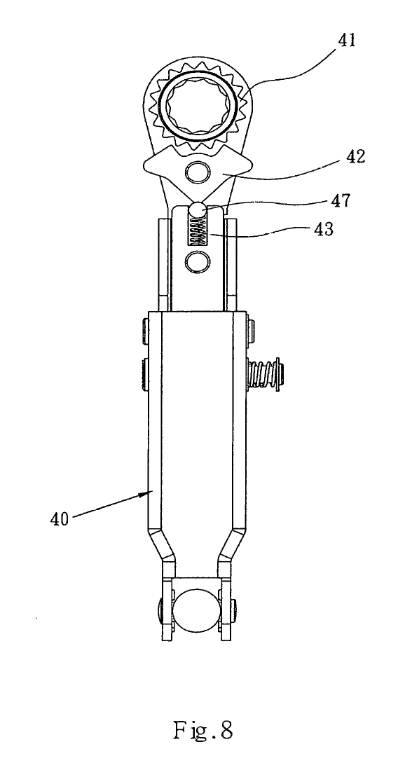

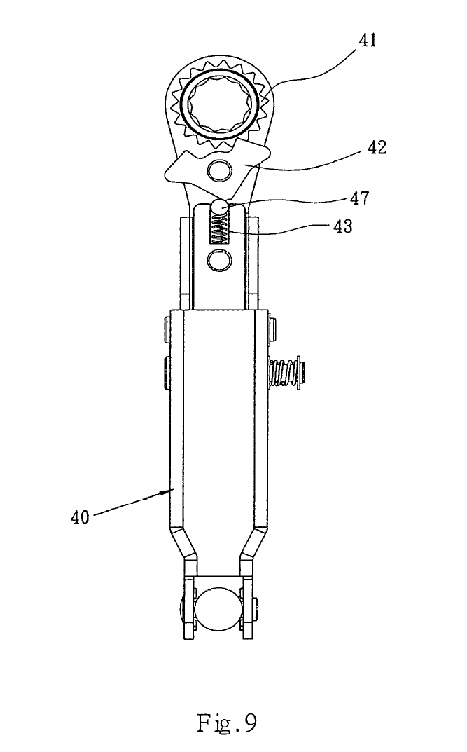

Please refer to FIGS. 7-9. The handle set 40 is provided with a ratcheted sleeve 41 axially connected to the transmission shaft 30. A claw 42 rotatably connected to the handle set 40 is elastically pushed by a ball 43 and a spring so that the ratcheted sleeve 41 can be set to a forward mode, a reverse mode and a neutral mode. The handle set 40 can be positioned at any desired position after it has tensioned the strap 70.

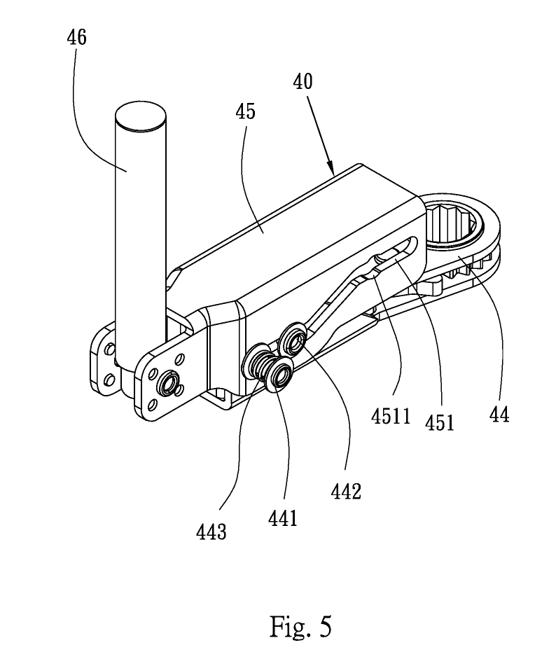

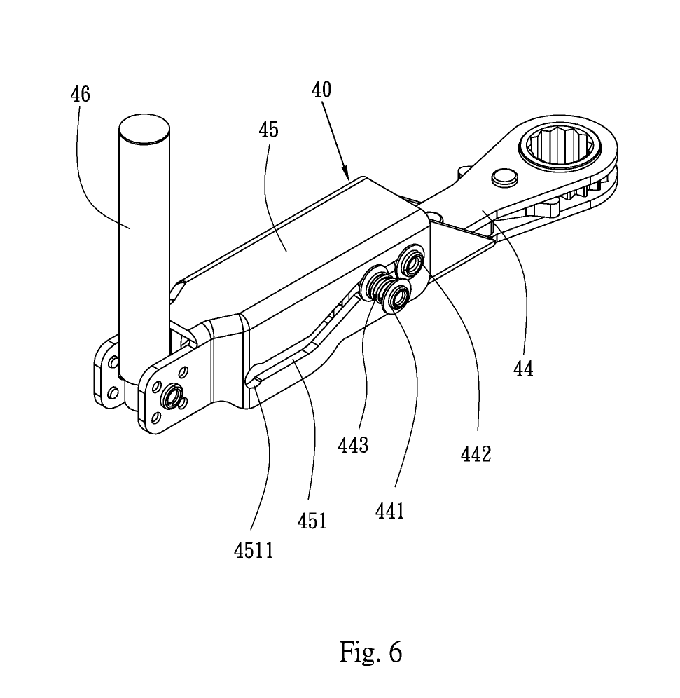

Please refer to FIGS. 5 and 6. The handle set 40 includes a crank 44 and an extendable stem 45. An outer end of the extendable stem 45 is rotatably connected to a handle bar 46 which can be turned up or down. The crank 44 is provided with a first bolt 441 and a second bolt 442, which penetrate a stepped sliding trough 451 in the extendable stem 45, so that the extendable stem 45 can be extended or retracted. Each of two ends of the sliding trough 451 is formed with an enlarged hole 4511. The first bolt 441 has a small spring 443 to press the extendable stem 45 to secure the extendable stem 45. The handle set 40 with the extendable stem 45 can save labor when rotating and save space when storing.

As shown in FIGS. 1 and 2, the first side wall 11 of the body 10 is further formed with an L-shaped holder 15. The handle set 40 can be restrained by the holder 15 when the handle set 40 is retracted and turned down.

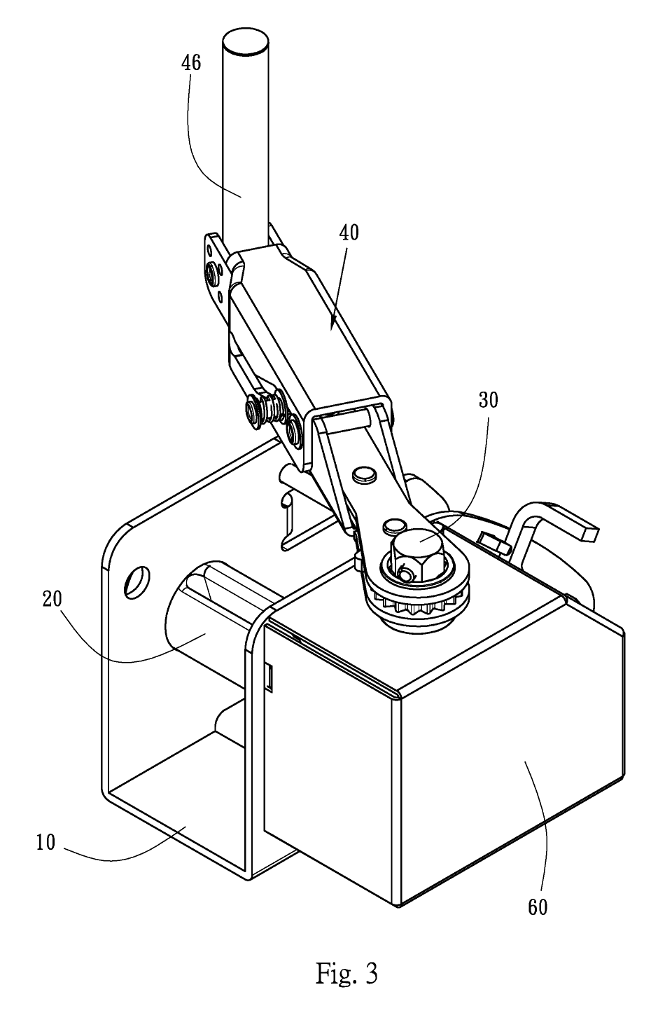

Please refer to FIGS. 3 and 4. A protective cover 60 may be provided to protect the bevel gears 23, 31.

It will be appreciated by persons skilled in the art that the above embodiment has been described by way of example only and not in any limitative sense, and that various alterations and modifications are possible without departure from the scope of the invention as defined by the appended claims.

1. A strap tensioning system comprising:
a body comprising a first side wall, a second side wall and a rod between the first and second side walls;
a main shaft set, pivoted between the first and second side walls, comprising a main shaft, and an end of the main shaft, which projects from the second side wall, being axially disposed with a ratchet and a first bevel gear, and both the ratchet and the first bevel gear being outside the body and adjacent to the second side wall;
a transmission shaft, pivoted outside the body with being orthogonal to the main shaft, a second bevel pear being axially connected around the transmission shaft, the second bevel gear engaging with the first bevel gear, and a gear ratio of the first and second bevel gears being 2:1;
a handle set radially connected to the transmission shaft for rotating the transmission shaft; and
a pawl set pivoted on the second side wall of the body, having a pawl fitting into one of a plurality of notches of the ratchet to prevent the main shaft set from reversing.

2. The strap tensioning system of claim 1, wherein each of the plurality of notches is formed between adjacent two of ratchet teeth, the pawl of the pawl set is formed into a V-shape, a side end of the pawl is formed to a pawl tip which is pressed by a torsion spring so that the pawl tip can be normally embedded into one of the notches, a cam is pivoted onto the second side wall of the body near the pawl, a limiting block is fixed on the second side wall to prevent the cam from overturning.

3. The strap tensioning system of claim 2, wherein a bar is disposed between the first and second side walls of the body, the bar is parallel to the main shaft set to keep a distance between the two side walls and to be hooked by the torsion spring.

4. The strap tensioning system of claim 2, wherein the pawl and the torsion spring are pivoted to the second side wall of the body by a pin and a washer.

5. The strap tensioning system of claim 1, wherein the handle set is provided with a ratcheted sleeve axially connected to the transmission shaft, a claw rotatably connected to the handle set is elastically pushed by a ball and a spring.

6. A strap tensioning system comprising:
a body comprising a first side wall, a second side wall and a rod between the first and second side walls;
a main shaft set, pivoted between the first and second side walls, comprising a main shaft, and an end of the main shaft, which projects from the second side wall, being disposed a ratchet and a first bevel gear, wherein the main shaft, the ratchet and the first bevel gear are integrated in a single piece;
a transmission shaft, pivoted outside the second side wall of the body, a second bevel gear being axially connected around the transmission shaft, the second bevel gear engaging with the first bevel gear, and a gear ratio of the first and second bevel gears being 2:1;
a handle sot axially connected to the transmission shaft for rotating the transmission shaft; and
a pawl set pivoted on the second side wall of the body, having a pawl fitting into a notch of the ratchet to prevent the main shaft set from reversing;
wherein the handle set comprises a crank and an extendable stem, an outer end of the extendable stem is rotatably connected to a handle bar, and the crank is provided with a first bolt and a second bolt, which penetrate a stepped sliding trough in the extendable stem, so that the extendable stem can be extended or retracted.

7. The strap tensioning system of claim 6, wherein each of two ends of the sliding trough is formed with an enlarged hole, and the first bolt has a spring to press the extendable stem to secure the extendable stem.

8. The strap tensioning system of claim 1, wherein the first side wall of the body is further formed with an L-shaped holder for restraining the handle set when the handle set is retracted and turned down.

9. The strap tensioning system of claim 1, wherein a protective cover is provided on the body to protect the bevel gears.
